(19) United States
(12) Patent Application Publication
(10) Pub. No.: US 2006/0239344 A1
(43) Pub. Date: Oct. 26, 2006

(54) Method and system for rate control in a video encoder

(76) Inventors: Ashish Koul, Cambridge, MA (US); Douglas Chin, Haverhill, MA (US); Stephen Gordon, North Andover, MA (US)

Correspondence Address: MCANDREWS HELD & MALLOY, LTD, 500 WEST MADISON STREET, SUITE 3400, CHICAGO, IL, 60661, US

(21) Appl. No.: 11/113,705

(22) Filed: Apr. 25, 2005

(51) Int. Cl. H04N 11/04

(52) U.S. Cl. 375/240.01

(57) ABSTRACT

Described herein is a method and system for rate control in a video encoder. The method and system can use relative persistence and intensity of video data in a macroblock to classify that macroblock. On a relative basis, a greater number of bits can be allocated to persistent video data with a low intensity. The quantization is adjusted accordingly. Adjusting quantization prior to video encoding enables a corresponding bit allocation that can preserve perceptual quality.

### RELATED APPLICATIONS

[Not Applicable]

### FEDERALLY SPONSORED RESEARCH OR DEVELOPMENT

[Not Applicable]

### MICROFICHE/COPYRIGHT REFERENCE

[Not Applicable]

### BACKGROUND OF THE INVENTION

Video communications systems are continually being enhanced to meet requirements such as reduced cost, reduced size, improved quality of service, and increased data rate. Many advanced processing techniques can be specified in a video compression standard. Typically, the design of a compliant video encoder is not specified in the standard. Optimization of the communication system's requirements is dependent on the design of the video encoder. An important aspect of the encoder design is rate control.

The video encoding standards can utilize a combination of encoding techniques such as intra-coding and inter-coding. Intra-coding uses spatial prediction based on information that is contained in the picture itself. Inter-coding uses motion estimation and motion compensation based on previously encoded pictures.

For all methods of encoding, rate control can be important for maintaining a quality of service and satisfying a bandwidth requirement. Instantaneous rate, in terms of bits per frame, may change over time. An accurate up-to-date estimate of rate must be maintained in order to control the rate of frames that are to be encoded.

Limitations and disadvantages of conventional and traditional approaches will become apparent to one of ordinary skill in the art through comparison of such systems with the present invention as set forth in the remainder of the present application with reference to the drawings.

### BRIEF SUMMARY OF THE INVENTION

Described herein are system(s) and method(s) for rate control while encoding video data, substantially as shown in and/or described in connection with at least one of the figures, as set forth more completely in the claims.

These and other advantages and novel features of the present invention will be more fully understood from the following description.

### BRIEF DESCRIPTION OF THE DRAWINGS

FIG. 1 is a block diagram of an exemplary picture in accordance with an embodiment of the present invention;

FIG. 2 is a block diagram describing temporally encoded macroblocks in accordance with an embodiment of the present invention;

FIG. 3 is a block diagram of an exemplary system with a rate controller in accordance with an embodiment of the present invention;

FIG. 4 is a flow diagram of an exemplary method for rate control in accordance with an embodiment of the present invention; and

FIG. 5 is a block diagram of an exemplary video encoding system in accordance with an embodiment of the present invention.

### DETAILED DESCRIPTION OF THE INVENTION

According to certain aspects of the present invention, a system and method for rate control in a video encoder are presented. By taking advantage of redundancies in a video stream, video encoders can reduce the bit rate while maintaining the perceptual quality of the picture. The reduced bit rate will save memory in applications that require storage such as DVD recording, and will save bandwidth for applications that require transmission such as HDTV broadcasting. Bits can be saved in video encoding by reducing space and time redundancies. Spatial redundancies are reduced when one portion of a picture can be predicted by another portion of the same picture.

Time redundancies are reduced when a portion of one picture can predict a portion of another picture. By classifying the intensity and persistence of a scene early in the encoding process, allocation of bits can be made to improve perceptual quality while maintaining an average bit rate.

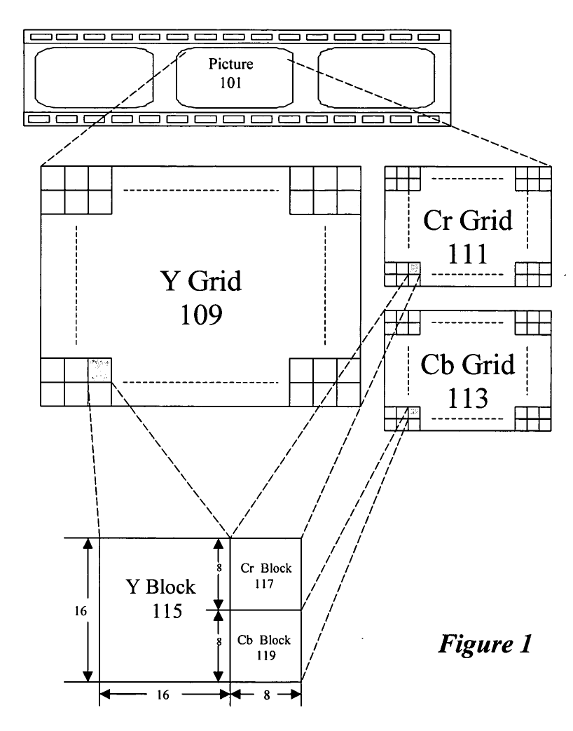

In FIG. 1 there is illustrated a diagram of an exemplary digital picture 101. The digital picture 101 comprises two-dimensional grid(s) of pixels. For color video, each color component is associated with a unique two-dimensional grid of pixels. For example, a picture can include luma, chroma red, and chroma blue components. Accordingly, these components can be associated with a luma grid 109, a chroma red grid 111, and a chroma blue grid 113. When the grids 109, 111, 113 are overlaid on a display device, the result is a picture of the field of view at the duration that the picture was captured.

Generally, the human eye is more perceptive to the luma characteristics of video, compared to the chroma red and chroma blue characteristics. Accordingly, there are more pixels in the luma grid 109 compared to the chroma red grid 111 and the chroma blue grid 113.

The luma grid 109 can be divided into 16×16 pixel blocks. For a luma block 115, there is a corresponding 8×8 chroma red block 117 in the chroma red grid 111 and a corresponding 8×8 chroma blue block 119 in the chroma blue grid 113. Blocks 115, 117, and 119 are collectively known as a macroblock.

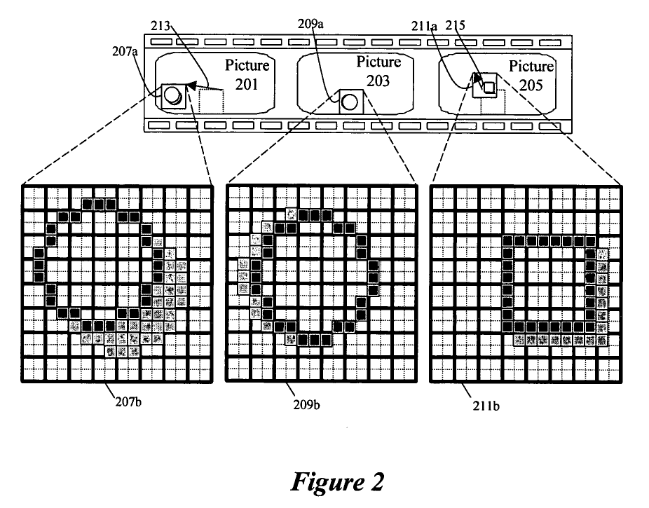

Referring now to FIG. 2, there is illustrated a sequence of pictures 201, 203, and 205 that can be used to describe motion estimation. A portion 209a in a current picture 203 can be predicted by a portion 207a in a previous picture 201 and a portion 211a in a future picture 205. Motion vectors 213 and 215 give the relative displacement from the portion 209a to the portions 207a and 211a respectively.

The quality of motion estimation is given by a cost metric. Referring now to the portions in detail 207b, 209b, and 211b. The cost of predicting can be the sum of absolute difference (SAD). The detailed portions 207b, 209b, and 211b are illustrated as 16×16 pixels. Each pixel can have a value—for example 0 to 255. For each position in the 16×16 grid, the absolute value of the difference between a pixel value in the portion 209b and a pixel value in the portion 207b is computed. The sum of these positive differences is a SAD for the portion 209a in the current picture 203 based on the previous picture 201. Likewise for each position in the 16×16 grid, the absolute value of the difference between a pixel value in the portion 209b and a pixel value in the portion 211b is computed. The sum of these positive differences is a SAD for the portion 209a in the current picture 203 based on the future picture 205.

FIG. 2 also illustrates an example of a scene change. In the first two pictures 201 and 203 a circle is displayed. In the third picture 205 a square is displayed. The SAD for portion 207b and 209b will be less than the SAD for portion 211b and 209b. This increase in SAD can be indicative of a scene change that may warrant a new allocation of bits.

Motion estimation may use a prediction from previous and/or future pictures. Unidirectional coding from previous pictures allows the encoder to process pictures in the same order as they are presented. In bidirectional coding, previous and future pictures are required prior to the coding of a current picture. Reordering in the video encoder is required to accommodate bidirectional coding.

Rate control can be based on a mapping of bit allocation to portions of pictures in a video sequence. There can be a baseline quantization level, and a deviation from that baseline can be generated for each portion. The baseline quantization level and deviation can be associated with a quantization parameter (QP) and a QP shift respectively. The QP shift can depend on metrics generated during video preprocessing. Intensity and SAD can be indicative of the content in a picture and can be used for the selection of the QP shift.

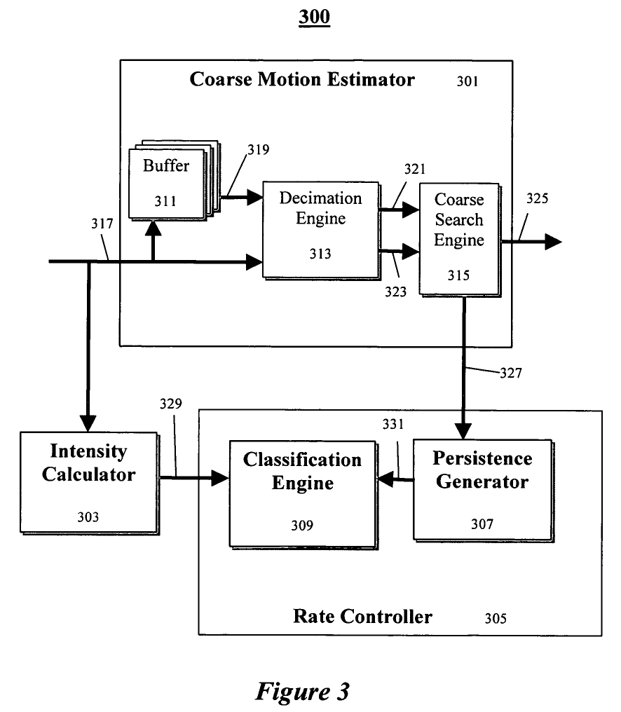

Referring now to FIG. 3, a block diagram of an exemplary system 300 with a rate controller 305 is shown. The system 300 comprises a coarse motion estimator 301, an intensity calculator 303, and the rate controller 305.

The coarse motion estimator 301 further comprises a buffer 311, a decimation engine 313, and a coarse search engine 315.

The coarse motion estimator 301 can store one or more original pictures 317 in a buffer 311. By using only original pictures 317 for prediction, the coarse motion estimator 301 can process picture prior to encoding.

The decimation engine 313 receives the current picture 317 and one or more buffered pictures 319. The decimation engine 313 produces a sub-sampled current picture 323 and one or more sub-sampled reference pictures 321. The decimation engine 313 can sub-sample frames using a 2×2 pixel average. Typically, the coarse motion estimator 301 operates on macroblocks of size 16×16. After sub-sampling, the size is 8×8 for the luma grid and 4×4 for the chroma grids. For MPEG-2, fields of size 16×8 can be sub-sampled in the horizontal direction, so a 16×8 field partition could be evaluated as size 8×8.

The coarse motion estimator 301 search can be exhaustive. The coarse search engine 315 determines a cost 327 for motion vectors 325 that describe the displacement from a section of a sub-sampled current picture 323 to a partition in the sub-sampled buffered picture 321. For each search position in the sub-sampled current picture 323, an estimation metric or cost 327 can be calculated. The cost 327 can be based on a sum of absolute difference (SAD). One motion vector 325 for every partition can be selected and used for further motion estimation. The selection is based on cost.

Coarse motion estimation can be limited to the search of large partitions (e.g. 16×16 or 16×8) to reduce the occurrence of spurious motion vectors that arise from an exhaustive search of small block sizes.

The intensity calculator 303 can determine the dynamic range 329 of the intensity by taking the difference between the minimum luma component and the maximum luma component in a macroblock 317.

For example, the macroblock 317 may contain video data having a distinct visual pattern where the color and brightness does not vary significantly. The dynamic range 329 can be quite low, and minor variations in the visual pattern are difficult to capture without the allocation of enough bits during the encoding of the macroblock 317. An indication of how many bits you should be adding to the macroblock 317 can be the dynamic range 329. A low dynamic range scene may require a negative QP shift such that more bits are allocated to preserve the texture and patterns.

A macroblock 317 that contains a high dynamic range 329 may also contain sections with texture and patterns, but the high dynamic range 329 can spatially mask out the texture and patterns. Dedicating fewer bits to the macroblock 317 with the high dynamic range 329 can result in little if any visual degradation.

Scenes that have high intensity differentials or dynamic ranges 329 can be given fewer bits comparatively. The perceptual quality of the scene can be preserved since the fine detail, that would require more bits, may be imperceptible. A high dynamic range 329 will lead to a positive QP shift for the macroblock 317.

For lower dynamic range macroblocks, more bits can be assigned. For higher dynamic range macroblocks, fewer bits can be assigned.

The human visual system can perceive intensity differences in darker regions more accurately than in brighter regions. A larger intensity change is required in brighter regions in order to perceive the same difference. The dynamic range can be biased by a percentage of the lumma maximum to take into account the brightness of the dynamic range. This percentage can be determined empirically. Alternatively, a ratio of dynamic range to lumma maximum can be computed and output from the intensity calculator 303.

The rate controller 305 comprises a persistence generator 307 and a classification engine 309. The persistence generator 307 receives the SAD values 327 for each macroblock to generate a persistence metric 331.

Elements of a scene that are persistent can be more noticeable. Whereas, elements of a scene that appear for a short period may have details that are less noticeable. More bits can be assigned when a macroblock is persistent. A macroblock 317 with a high persistence 331 can have a relatively low SAD 327 since it can be well predicted. Macroblocks that persists for several frames can be assigned more bits since errors in those macroblocks are going to be more easily perceived.

The classification engine 309 can determine relative bit allocation. The classification engine 309 can elect a QP shift value for every macroblock during preencoding. The rate controller 305 can select a nominal QP. Relative to that nominal QP the current macroblock 317 can have a QP shift that indicates encoding with quantization level that is deviated from the nominal. A lower QP (negative QP shift) indicates more bits are being allocated, a higher QP (positive QP shift) indicates less bits are being allocated.

The QP shift for the SAD and the QP shift for the dynamic range can be independently calculated. If these metrics are independently calculated, the QP shift for the SAD persistence is weighted by a temporal weight, and the QP shift for the dynamic range of the intensity is weighted by the range weight. The weighted QP shift values are summed. The temporal weight and the range weight can be empirically determined. For example, the weights may be 0.5 and 0.5.

As dynamic range increases QP shift will go from a large negative to a large positive.

An example dynamic range vs. QP shift table may have 32 rows that correspond to equally spaced dynamic range values. The dynamic range vs. QP shift table can be empirically determined.

An example SAD vs. QP shift table may have rows that are exponentially allocated. Each new row may correspond to a doubling of the SAD value. The SAD vs. QP shift table can be empirically determined.

The set QP shift values for a picture can form a quantization map. The rate controller 305 can use the quantization map to allocate an appropriate number of bits based on a priori classification.

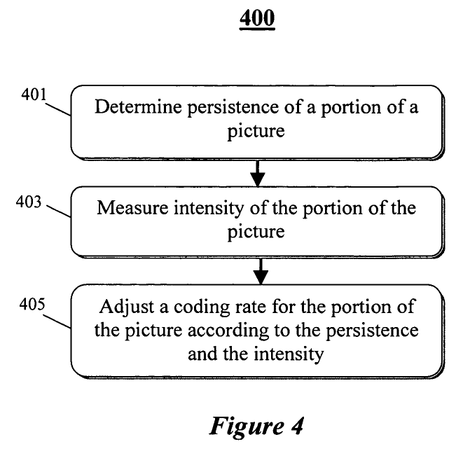

FIG. 4 is a flow diagram 400 of an exemplary method for rate control in accordance with an embodiment of the present invention.

Persistence for a portion of a picture is determined at 401. The persistence can be based on a difference between the portion of the picture and a portion of a previous picture. The persistence can be based on one or more motion estimation metrics, wherein a motion estimation metric is a sum of absolute difference between the portion of the picture and a portion of a previous picture. A repetition of motion estimation metrics that are low can indicate persistent video content. A threshold for determining when a value is low can be determined empirically based on scenes that are considered persistent and scenes that are not considered persistent.

Intensity for the portion of the picture is measured at 403. The intensity can be based on a dynamic range of lumma values. A large difference between the maximum lumma value and the minimum lumma value corresponds to a larger dynamic range and a greater intensity.

A coding rate for the portion of the picture is adjusted at 405 according to the persistence and the intensity. A larger number of bits can be allocated to the portion of the picture when the persistence is high. A larger number of bits can be allocated to the portion of the picture when the intensity is low.

This invention can be applied to video data encoded with a wide variety of standards, one of which is H.264. An overview of H.264 will now be given. A description of an exemplary system for scene change detection in H.264 will also be given.

H.264 Video Coding Standard

The ITU-T Video Coding Experts Group (VCEG) and the ISO/IEC Moving Picture Experts Group (MPEG) drafted a video coding standard titled ITU-T Recommendation H.264 and ISO/IEC MPEG-4 Advanced Video Coding, which is incorporated herein by reference for all purposes. In the H.264 standard, video is encoded on a macroblock-by-macroblock basis. The generic term “picture” refers to frames and fields.

The specific algorithms used for video encoding and compression form a video-coding layer (VCL), and the protocol for transmitting the VCL is called the Network Access Layer (NAL). The H.264 standard allows a clean interface between the signal processing technology of the VCL and the transport-oriented mechanisms of the NAL, so source-based encoding is unnecessary in networks that may employ multiple standards.

By using the H.264 compression standard, video can be compressed while preserving image quality through a combination of spatial, temporal, and spectral compression techniques. To achieve a given Quality of Service (QoS) within a small data bandwidth, video compression systems exploit the redundancies in video sources to de-correlate spatial, temporal, and spectral sample dependencies. Statistical redundancies that remain embedded in the video stream are distinguished through higher order correlations via entropy coders. Advanced entropy coders can take advantage of context modeling to adapt to changes in the source and achieve better compaction.

An H.264 encoder can generate three types of coded pictures: Intra-coded (I), Predictive (P), and Bidirectional (B) pictures. Each macroblock in an I picture is encoded independently of other pictures based on a transformation, quantization, and entropy coding. I pictures are referenced during the encoding of other picture types and are coded with the least amount of compression. Each macroblock in a P picture includes motion compensation with respect to another picture. Each macroblock in a B picture is interpolated and uses two reference pictures. The picture type I uses the exploitation of spatial redundancies while types P and B use exploitations of both spatial and temporal redundancies. Typically, I pictures require more bits than P pictures, and P pictures require more bits than B pictures.

H.264 may produce an artifact that may be referred to as I-Frame clicking. The prediction characteristics of an I-Frame can be different from a P-frame or a B-frame. When the difference is large, the I-Frame could produce a sudden burst on the screen. I-Frames could, for example, be produced once a second. A periodic burst of this kind can be irritating to the viewer. Classification can combat I-Frame clicking. The areas where I-Frame clicking can be most apparent are the persistent areas and the darker areas that the classification engine looks for.

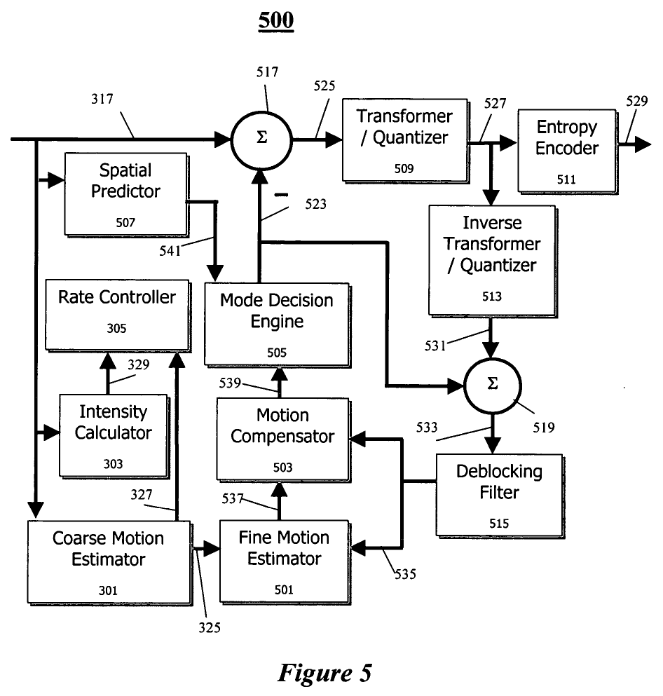

Referring now to FIG. 5, there is illustrated a block diagram of an exemplary video encoder 500. The video encoder 500 comprises a fine motion estimator 501, the coarse motion estimator 301 of FIG. 3, a motion compensator 503, a mode decision engine 505, a spatial predictor 507, the intensity calculator 303 of FIG. 3, the rate controller 305 of FIG. 3, a transformer/quantizer 509, an entropy encoder 511, an inverse transformer/quantizer 513, and a deblocking filter 515.

The spatial predictor 507 uses only the contents of a current picture 217 for prediction. The spatial predictor 507 receives the current picture 217 and can produce a spatial prediction 541.

Spatially predicted partitions are intra-coded. Luma macroblocks can be divided into 4×4 or 16×16 partitions and chroma macroblocks can be divided into 8×8 partitions. 16×16 and 8×8 partitions each have 4 possible prediction modes, and 4×4 partitions have 9 possible prediction modes.

In the coarse motion estimator 301, the partitions in the current picture 317 are estimated from other original pictures. The other original pictures may be temporally located before or after the current picture 317, and the other original pictures may be adjacent to the current picture 317 or more than a frame away from the current picture 317. To predict a target search area, the coarse motion estimator 301 can compare large partitions that have been sub-sampled. The coarse motion estimator 301 will output an estimation metric 327 and a coarse motion vector 325 for each partition searched.

The fine motion estimator 501 predicts the partitions in the current picture 317 from reference partitions 535 using the set of coarse motion vectors 325 to define a target search area. A temporally encoded macroblock can be divided into 16×8, 8×16, 8×8, 4×8, 8×4, or 4×4 partitions. Each partition of a 16×16 macroblock is compared to one or more prediction blocks in previously encoded picture 535 that may be temporally located before or after the current picture 317.

The fine motion estimator 501 improves the accuracy of the coarse motion vectors 325 by searching partitions of variable size that have not been sub-sampled. The fine motion estimator 501 can also use reconstructed reference pictures 535 for prediction. Interpolation can be used to increase accuracy of a set of fine motion vectors 537 to a quarter of a sample distance. The prediction values at half-sample positions can be obtained by applying a 6-tap FIR filter or a bilinear interpolator, and prediction values at quarter-sample positions can be generated by averaging samples at the integer- and half-sample positions. In cases where the motion vector points to an integer-sample position, no interpolation is required.

The motion compensator 503 receives the fine motion vectors 537 and generates a temporal prediction 539. Motion compensation runs along with the main encoding loop to allow intra-prediction macroblock pipelining.

The estimation metric 327 and the dynamic range 329 generated by the intensity calculator 303 are used to enable the rate controller 305 as described with reference to FIG. 2.

The mode decision engine 505 will receive the spatial prediction 541 and temporal prediction 539 and select the prediction mode according to a sum of absolute transformed difference (SATD) cost that optimizes rate and distortion. A selected prediction 523 is output.

Once the mode is selected, a corresponding prediction error 525 is the difference 517 between the current picture 521 and the selected prediction 523. The transformer/quantizer 509 transforms the prediction error and produces quantized transform coefficients 527. In H.264, there are 52 quantization parameters.

Transformation in H.264 utilizes Adaptive Block-size Transforms (ABT). The block size used for transform coding of the prediction error 525 corresponds to the block size used for prediction. The prediction error is transformed independently of the block mode by means of a low-complexity 4×4 matrix that together with an appropriate scaling in the quantization stage approximates the 4×4 Discrete Cosine Transform (DCT). The Transform is applied in both horizontal and vertical directions. When a macroblock is encoded as intra 16×16, the DC coefficients of all 16 4×4 blocks are further transformed with a 4×4 Hardamard Transform.

H.264 specifies two types of entropy coding: Context-based Adaptive Binary Arithmetic Coding (CABAC) and Context-based Adaptive Variable-Length Coding (CAVLC). The entropy encoder 511 receives the quantized transform coefficients 527 and produces a video output 529. In the case of temporal prediction, a set of picture reference indices may be entropy encoded as well.

The quantized transform coefficients 527 are also fed into an inverse transformer/quantizer 513 to produce a regenerated error 531. The original prediction 523 and the regenerated error 531 are summed 519 to regenerate a reference picture 533 that is passed through the deblocking filter 515 and used for motion estimation.

The embodiments described herein may be implemented as a board level product, as a single chip, application specific integrated circuit (ASIC), or with varying levels of a video classification circuit integrated with other portions of the system as separate components. An integrated circuit may store a supplemental unit in memory and use an arithmetic logic to encode, detect, and format the video output.

The degree of integration of the rate control circuit will primarily be determined by the speed and cost considerations. Because of the sophisticated nature of modern processors, it is possible to utilize a commercially available processor, which may be implemented external to an ASIC implementation.

If the processor is available as an ASIC core or logic block, then the commercially available processor can be implemented as part of an ASIC device wherein certain functions can be implemented in firmware as instructions stored in a memory. Alternatively, the functions can be implemented as hardware accelerator units controlled by the processor.

While the present invention has been described with reference to certain embodiments, it will be understood by those skilled in the art that various changes may be made and equivalents may be substituted without departing from the scope of the present invention.

Additionally, many modifications may be made to adapt a particular situation or material to the teachings of the present invention without departing from its scope. For example, although the invention has been described with a particular emphasis on one encoding standard, the invention can be applied to a wide variety of standards.

Therefore, it is intended that the present invention not be limited to the particular embodiment disclosed, but that the present invention will include all embodiments falling within the scope of the appended claims.

1. A method for rate control in a video encoder, said method comprising:
determining a persistence for a portion of a picture;
measuring an intensity for the portion of the picture; and
adjusting a coding rate for the portion of the picture according to the persistence and the intensity.

2. The method of claim 1, wherein the persistence is based on a difference between the portion of the picture and a portion of a previous picture.

3. The method of claim 1, wherein the persistence is based on one or more motion estimation metrics.

4. The method of claim 3, wherein a motion estimation metric is a sum of absolute difference between the portion of the picture and a portion of a previous picture.

5. The method of claim 1, wherein adjusting a coding rate further comprises:
allocating a larger number of bits to the portion of the picture when the persistence is high.

6. The method of claim 1, wherein the intensity is based on a range of lumma values.

7. The method of claim 1, wherein adjusting a coding rate further comprises:
allocating a larger number of bits to the portion of the picture when the intensity is low.

8. A system for rate control in a video encoder, said system comprising:
a persistence generator for determining a persistence for a portion of a picture;
an intensity calculator for measuring an intensity for the portion of the picture; and
a rate controller for adjusting a coding rate for the portion of the picture according to the persistence and the intensity.

9. The system of claim 8, wherein the persistence is based on a difference between the portion of the picture and a portion of a previous picture.

10. The system of claim 8, wherein the system further comprises:
a motion estimator for generating a motion estimation metric, wherein the persistence is based on the motion estimation metric.

11. The system of claim 10, wherein a motion estimation metric is a sum of absolute difference between the portion of the picture and a portion of a previous picture.

12. The system of claim 8, wherein rate controller further comprises:
a classification engine for allocating a larger number of bits to the portion of the picture when the persistence is high.

13. The system of claim 8, wherein the intensity is based on a dynamic range of lumma values.

14. The system of claim 8, wherein rate controller further comprises:
a classification engine for allocating a larger number of bits to the portion of the picture when the intensity is low.

15. A system for rate control in a video encoder, said system comprising:
an integrated circuit comprising:
a first circuit for determining a persistence for a portion of a picture;
a second circuit for measuring an intensity for the portion of the picture; and
a third circuit for adjusting a coding rate for the portion of the picture according to the persistence and the intensity.

16. The system of claim 15, wherein the integrated circuit further comprises:
a motion estimator for generating a set of motion estimation metrics, wherein the persistence for the portion of the picture is based on a number of motion estimation metrics in the set of motion estimation metrics that are below a threshold.

17. The system of claim 15, wherein the third circuit is further operable for allocating a larger number of bits to the portion of the picture when the persistence is high.

18. The system of claim 15, wherein the third circuit is further operable for allocating a larger number of bits to the portion of the picture when the intensity is low.
